(19) United States
(12) Patent Application Publication
(10) Pub. No.: US 2006/0043742 A1
(43) Pub. Date: Mar. 2, 2006

(54) Door lock mechanism having an adjusting window

(76) Inventors: Chao-Ming Huang, Kaohsiung Hsien (TW); Chung-Chi Wu, Kaohsiung Hsien (TW)

Correspondence Address: BIRCH STEWART KOLASCH & BIRCH, PO BOX 747, FALLS CHURCH, VA, 22040-0747, US

(21) Appl. No.: 10/930,834

(22) Filed: Sep. 1, 2004

(51) Int. Cl. E05B 3/00

(52) U.S. Cl. 292/336.3

(57) ABSTRACT

A door lock mechanism includes a mounting plate, an actuating plate and at least two elastic members to constitute an inner assembly. The mounting plate has at least two hook members while the actuating plate having at least two hook members, an adjusting window and a limiting member. Each of the elastic members has a first end and a second end for engaging with the hook members of the mounting plate and the actuating plate. At least one of the elastic members is aligned with the adjusting window of the actuating plate for releasing the elastic member. The limiting member is used to position the released elastic member to avoid falling off.

### BACKGROUND OF THE INVENTION

1. Field of the Invention

The present invention relates to a door lock mechanism having an adjusting window. More particularly, the present invention relates to a door lock mechanism having an adjusting window for adjusting an elastic force to operate a doorknob.

2. Description of the Related Art

Taiwanese Patent Publication No. 263,997, entitled “Door Lock Mechanism,” discloses an outside escutcheon and an inside escutcheon attached to an outside doorplate and an inside doorplate respectively. The outside doorplate includes an auxiliary lock and an outside doorknob while the inside doorplate including a turn button and an inside doorknob. In installing operation, a spindle of the turn button and the inside doorknob are combined with a mounting plate which provides with a first hook member and a spring member connected thereto. The first hook member of the mounting plate mechanically connects to an end of the spring member. The door lock mechanism further includes an actuating plate and a second hook member thereof. The second hook member of the actuating plate mechanically connects to the other end of the spring member.

In operation, the auxiliary lock and the turn button are permitted to unlock or retract a deadbolt of a deadbolt unit. And, both of the outside doorknob and the inside doorknob are permitted to unlock or retract a latch bolt of a latch unit. In addition, the inside doorknob is also permitted to unlock the deadbolt of the deadbolt unit via the actuating plate.

In assembling operation, the outside and inside doorknobs can be selected from a group consisting of a tubular doorknob and a lever doorknob according to the demand of products. In order to easily turn and return the tubular doorknob, a smaller amount of the spring members or a weaker spring member must be adopted to operate the tubular doorknob with a smaller operational force. Alternatively, in order to properly turn and return the lever doorknob, a larger amount of the spring members or a stronger spring member is adopted to operate the lever doorknob with a greater force. In manufacture, selecting the amount of the spring members or changing the type of the spring members may complicate the entire process and increase manufacture cost due to fabricating new component molds and arranging new production lines.

To assemble the door lock mechanism, the inside doorknob is integrally connected to the spindle and inner components or welded to the spindle and inner components. Accordingly, when different types of the tubular doorknobs or the lever doorknobs are employed, the spindle and the inner components of the door lock mechanism must be changed and redesigned that may result in an increase of the manufacture cost. Hence, there is a need for solving the problems of the door lock mechanism.

The present invention intends to provide a door lock mechanism having an adjusting window for adjusting an elastic force to operate a doorknob. The door lock mechanism includes a mounting plate, an actuating plate and at least two elastic members located between the mounting plate and the actuating plate. For providing with two different elastic forces, one or two of the elastic members is selected to connect the mounting plate with the actuating plate that is suitable for a tubular doorknob or a lever doorknob. Thereby, a single inner assembly of the door lock mechanism is suitable for the tubular doorknob or the lever doorknob in such a way to mitigate and overcome the above problem.

### SUMMARY OF THE INVENTION

The primary objective of this invention is to provide a door lock mechanism having an adjusting window for selecting two different operational forces. For saving manufacture cost, the door lock mechanism provides a single module of an inner lock assembly with two different operational forces for a tubular doorknob or a lever doorknob.

The secondary objective of this invention is to provide a door lock mechanism having a single spindle for combining with two different types of a tubular doorknob and a lever doorknob. Thereby, it may simplify the entire structure of the door lock mechanism.

Another objective of this invention is to provide a door lock mechanism having a one-piece member of an actuating rod and an engaging end. Thereby, it may insure the turning operation and extend the useful life of the door lock mechanism.

The door lock mechanism in accordance with the present invention includes a mounting plate, an actuating plate and at least two elastic members to constitute an inner assembly. The mounting plate has at least two hook members while the actuating plate having at least two hook members, an adjusting window and a limiting member. Each of the elastic members has a first end and a second end for engaging with the hook members of the mounting plate and the actuating plate. At least one of the elastic members is aligned with the adjusting window of the actuating plate for selectively releasing the elastic member. The limiting member is used to position the released elastic member to avoid falling off.

Other objectives, advantages and novel features of the invention will become more apparent from the following detailed description and the accompanying drawings.

### BRIEF DESCRIPTION OF THE DRAWINGS

The present invention will now be described in detail with reference to the accompanying drawings wherein:

FIG. 1 is a perspective view of an actuating plate of a door lock mechanism having an adjusting window in accordance with a preferred embodiment of the present invention;

FIG. 2 is an assembled front plan view of the actuating plate of the door lock mechanism having the adjusting window in accordance with the preferred embodiment of the present invention;

FIG. 3 is a cross-sectional view, taken along line 3-3 in FIG. 2, of the door lock mechanism in accordance with the preferred embodiment of the present invention;

FIG. 4 is a cross-sectional view, taken along line 4-4 in FIG. 2, of the door lock mechanism in accordance with the preferred embodiment of the present invention;

FIG. 5 a cross-sectional view, similar to FIG. 3, of the door lock mechanism in accordance with the preferred embodiment of the present invention when adjusting an elastic member in an alternative use; and

FIG. 6 a cross-sectional view, similar to FIG. 5, of the door lock mechanism in accordance with the preferred embodiment of the present invention after adjusting the elastic member.

### DETAILED DESCRIPTION OF THE INVENTION

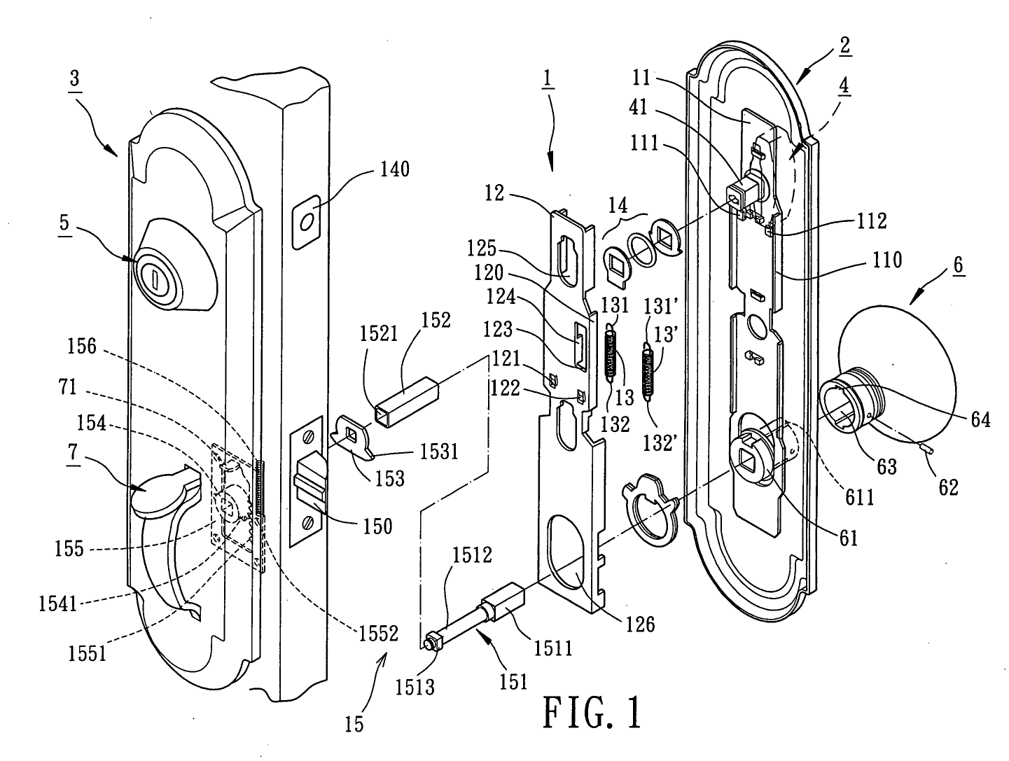

Referring initially to FIG. 1, it depicts a door lock mechanism in accordance with a preferred embodiment of the present invention. In this preferred embodiment, the door lock mechanism generally includes an inner lock assembly 1, an inside escutcheon 2, an outside escutcheon 3, a turn button 4, an auxiliary lock 5, an inside doorknob 6 and an outside doorknob 7. The lock assembly 1, the inside escutcheon 2, the turn button 4 and the inside doorknob 6 are commonly secured on an inner surface of a doorplate. Correspondingly, the outside escutcheon 3, the auxiliary lock 5 and the outside doorknob 7 are commonly secured on an outer surface of the doorplate.

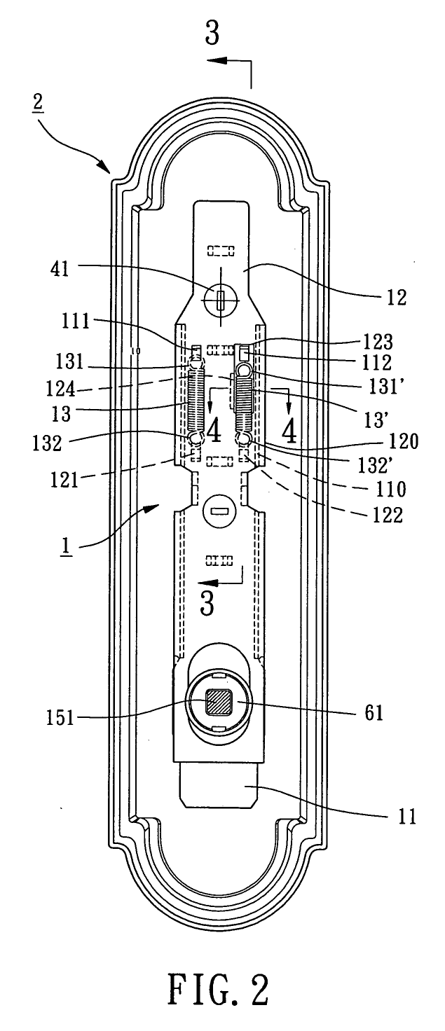

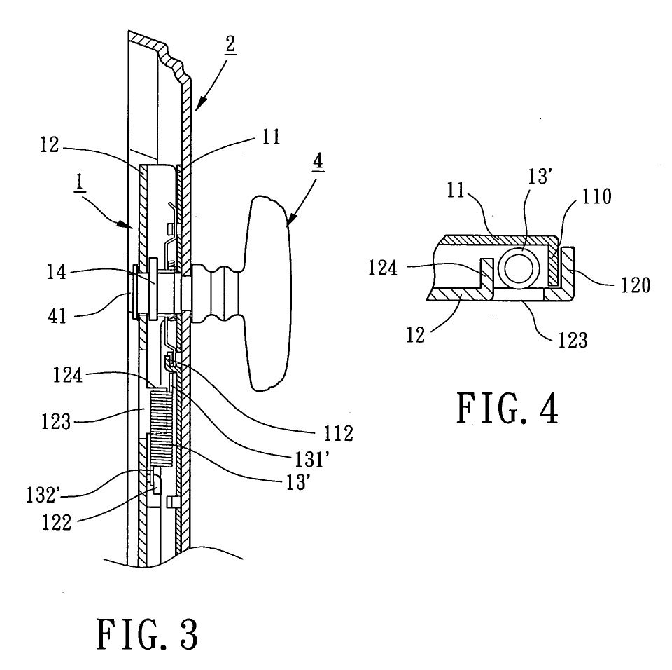

Turning now to FIGS. 1 through 4, the construction of the inner lock assembly 1 shall now be described in detail. The inner lock assembly 1 includes a mounting plate 11, an actuating plate 12, at least two elastic members 13, 13′, a deadbolt unit 14 and a latch unit 15. The inside escutcheon 2 accommodates and mounts the mounting plate 11 which includes a pair of upright flanges 110 and at least two hook members 111, 112. Correspondingly, the actuating plate 12 includes a pair of upright flanges 120, at least two hook members 121, 122, at least one adjusting window 123, at least one limiting member 124, an upper combination hole 125 and a lower combination hole 126. The upright flanges 110 of the mounting plate 11 confine and guide the upright flanges 120 of the actuating plate 12 that permit a longitudinal movement of the actuating plate 12 along the mounting plate 11. The elastic member 13 has a first end 131 and a second end 132. The first end 131 of the elastic member 13 mechanically connects to the hook member 111 of the mounting plate 11 while the second end 132 of the elastic member 13 mechanically connecting to the hook member 121 of the actuating plate 12. Correspondingly, the elastic member 13′ has a first end 131′ and a second end 132′. In use, the first end 131′ and the second end 132′ of the elastic member 13′ mechanically connect to the hook member 112 of the mounting plate 11 and the hook member 122 of the actuating plate 12. Alternatively, the first end 131′ of the elastic member 13′ disconnects to the hook member 112 of the mounting plate 11 according to the demand for the type of the doorknob. At that time, the elastic member 13′ is aligned with the adjusting window 123 of the actuating plate 12. Preferably, the limiting member 124 is an upright bent member punched in the actuating plate 12 and used to confine the elastic member 13′ to prevent from falling off.

Still referring to FIGS. 1 through 4, the construction of the turn button 4 and the auxiliary lock 5 shall now be described in detail. The turn button 4 includes a spindle 41 rotatably connected to the inside escutcheon 2 and the mounting plate 11. Correspondingly, the inside doorknob 6 includes a spindle 61 rotatably connected to the inside escutcheon 2 and the mounting plate 11. The deadbolt unit 14 connects to the spindle 41 of the turn button 4 through the upper combination hole 125 of the actuating plate 12, and further connects to the auxiliary lock 5. In locking and unlocking operation, the longitudinal movement of the actuating plate 12 is able to actuate the deadbolt unit 14 so as to extend or retract a deadbolt 140.

Still referring to FIGS. 1 and 4, the latch unit 15 connects to the spindle 61 of the inside doorknob 6 through the lower combination hole 126 of the actuating plate 12. In operation, turning the inside doorknob 6 or actuating the outside doorknob 7 is able to control extending or retracting a latch bolt 150 of the latch unit 15. In particular, turning the inside doorknob 6 causes the latch unit 15 to drive the actuating plate 12 that may unlock the auxiliary lock 5 and the deadbolt 140 of the deadbolt unit 14 without turning the turn button 4.

Still referring to FIGS. 1 and 4, only a smaller biasing force actuates the actuating plate 12 when the two ends 131, 132 of the single elastic member 13 connects between the two hook members 111, 121 of the mounting plate 11 and the actuating plate 12. Thus, the inner lock assembly 1 is suitable for a smaller returning force of the inside doorknob 6, a tubular doorknob for example. At that time, only the second end 132′ of the elastic member 13′ connects to the hook member 122 of the actuating plate 12, and the elastic member 13′ is positioned between the upright flange 120 and the limiting member 124 of the actuating plate 12. Preferably, a length of the hook member 122 of the actuating plate 12 is greater than that of the second end 132′ of the elastic member 13′. Thus, the second end 132′ of the elastic member 13′ cannot release from the hook member 122 of the actuating plate 12 when the first end 131′ of the elastic member 13′ disconnects from the hook member 112 of the mounting plate 11. Additionally, between the hook member 112 of the mounting plate 11 and the first end 131′ of the elastic member 13′ is spaced an adequate distance apart when the actuating plate 12 moves the first end 131′ of the elastic member 13′ closer to the hook member 112 of the mounting plate 11. Consequently, it can avoid the first end 131′ of the elastic member 13′ hooking the hook member 112 of the mounting plate 11 by accident.

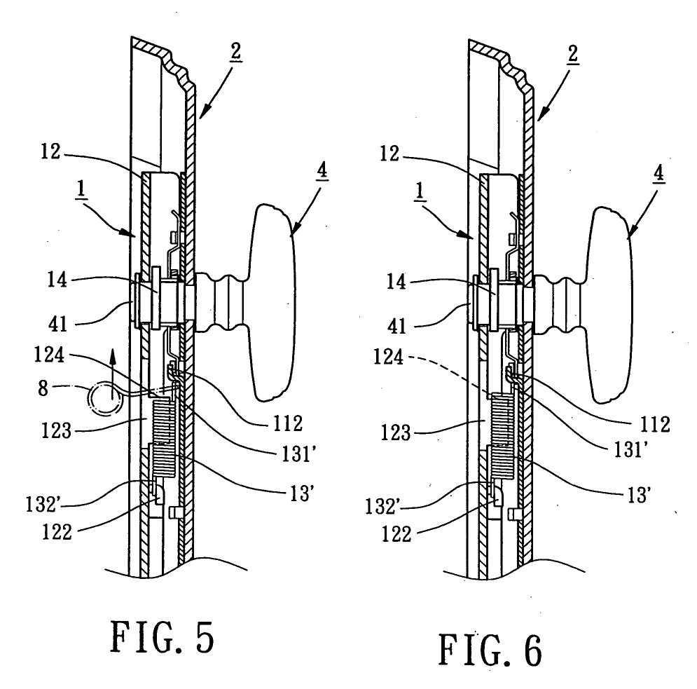

Referring again to FIGS. 5 and 6, in an alternative use, the first ends 131, 131′ of the elastic members 13, 13′ secure to the hook members 111, 112 of the mounting plate 11. Correspondingly, the second ends 132, 132′ of the elastic members 13, 13′ secure to the hook members 121, 122 of the actuating plate 12 that a greater biasing force actuates the actuating plate 12. Thus, the inner lock assembly 1 is suitable for a greater returning force of the inside doorknob 6, a lever doorknob for example.

Referring again to FIG. 5, the adjusting operation of the elastic member 13′ shall now be described in detail. A tool 8 extends through the adjusting window 123 to selectively engage or disengage the first end 131′ of the elastic member 13′ with or from the hook member 112 of the mounting plate 11 according to the demand of products. Consequently, the two elastic members 13, 13′ of the inner lock assembly 1 is suitable for two different types of the inside doorknobs 6 that may simplify the entire structure and reduce manufacture cost.

Referring again to FIG. 1, when the spindle 61 of the inside doorknob 6 is initially combined with the inside escutcheon 2 and the mounting plate 11, the spindle 61 employs at least one screw member 62 to connect to the inside doorknob 6. Preferably, the spindle 61 further includes a positioning rib 611, and an axle hole 63 of the inside doorknob 6 correspondingly includes a positioning groove 64. In assembling operation, the positioning rib 611 of the spindle 61 engages with the positioning groove 64 of the axle hole 63 of the inside doorknob 6. It will be apparent that the inside doorknob 6 can be changed one of the tubular doorknob or the lever doorknob by releasing the screw member 62 without taking apart the spindle 61 from the inside escutcheon 2 and the mounting plate 11. Consequently, it may simplify the assembling operation and the entire structure of the inside doorknob 6.

Referring back to FIG. 1, the construction of the latch unit 15 shall now be described in detail. The latch unit 15 further includes an actuating rod 151, an unlocking tube 152, a pushing member 153, a cam 154, an actuating frame 155 and a returning spring 156 in addition to the latch bolt 150. The actuating rod 151 is a one-piece member integrally forming a non-circular rod 1511, a connection rod 1512 and a non-circular head 1513 in a casting or milling manner. Preferably, the actuating rod 151 is relatively strong enough to withstand normal use of the door lock mechanism. It will be apparent that the entire structure of the actuating rod 151 is intensified to insure the operation of the inner lock assembly 1.

Still referring to FIG. 1, the non-circular rod 1511 of the actuating rod 151 engages with the spindle 61 of the inside doorknob 6. The unlocking tube 152 includes a through hole 1521 through which to extend the connection rod 1512 and the non-circular head 1513 of the actuating rod 151. The unlocking tube 152 is located at an inner side of the actuating frame 155 proximate an inside of the doorplate and connected with the cam 154 and the latch bolt 150. The non-circular head 1513 of the actuating rod 151 extends through the actuating frame 155 and connects with the pushing member 153 at an outside doorplate. The pushing member 153 has at least one engaging lug 1531. The cam 154 is also located in the actuating frame 155, and has teeth 1541. Correspondingly, the actuating frame 155 includes a rack 1551 and at least one protrusion 1552. The teeth 1541 of the cam 154 engages with the rack 1551 of the actuating frame 155 while the engaging lug 1531 of the pushing member 153 abutting against the protrusion 1552 of the actuating frame 155. Preferably, the protrusion 1552 is provided on an outer side of the actuating frame 155 proximate an outside of the doorplate. To generate a returning movement of the actuating frame 155, a specific press force of the returning spring 156 successively actuates the actuating frame 155.

Still referring to FIG. 1, after the deadbolt 140 of the deadbolt unit 14 is unlocked, turning the outside doorknob 7 can cause a thumb piece actuator 71 to move the actuating frame 155 upward within the outside escutcheon 3. Subsequently, the rack 1551 of the actuating frame 155 turns the teeth 1541 of the cam 154 for a rotational movement. Consequently, the cam 154 rotates the unlocking tube 152 that unlocks the latch bolt 150 of the latch unit 15 for opening the doorplate. Meanwhile, the unlocking tube 152 is still unable to rotate the actuating rod 151 that the actuating frame 155 does not actuate the pushing member 153 to avoid synchronously rotating the inside doorknob 6.

Alternatively, turning the inside doorknob 6 can cause the spindle 61 to turn the pushing member 153 through the non-circular head 1513 of the actuating rod 151. Subsequently, the engaging lug 1531 of the pushing member 153 pushes the protrusion 1552 of the actuating frame 155 upward that moves the actuating frame 155 upward. Consequently, the rack 1551 of the actuating frame 155 turns the teeth 1541 of the cam 154 that rotates the unlocking tube 152 to unlock the latch bolt 150 of the latch unit 15 for opening the doorplate.

However, the conventional door lock mechanism is unsuitable for two different types of the doorknobs. It will be apparent from the aforementioned discussions that the actuating plate 12 includes the adjusting window 123 and the limiting plate 124 for connecting or disconnecting the first end 131′ of the elastic member 13′ with or from the hook member 112 of the mounting plate 11. Therefore, a single module of the inner lock assembly 1 is suitable for two different types of the doorknob that may simplify the entire structure of the inner lock assembly 1 and reduce manufacture cost.

Although the invention has been described in detail with reference to its presently preferred embodiment, it will be understood by one of ordinary skill in the art that various modifications can be made without departing from the spirit and the scope of the invention, as set forth in the appended claims.

What is claimed is:

1. A door lock mechanism having an inner lock assembly comprising:
a mounting plate including a pair of first upright flanges and at least two first hook members;
an actuating plate including a pair of second upright flanges and at least two second hook members, the first upright flanges of the mounting plate confine and guide the second upright flanges of the actuating plate that permit a longitudinal movement of the actuating plate along the mounting plate;
at least two elastic members each having a first end and a second end, the first ends of the two elastic members connect with the first hook members of the mounting plate while the second ends of the two elastic members connecting with the second hook members of the mounting plate; and
an adjusting window provided on the actuating plate and aligned with one of the first ends of the two elastic members engaging with one of the first hook members of the mounting plate so that said first end of the elastic member can be disconnected from the first hook member of the mounting plate through the adjusting window.

2. The door lock mechanism as defined in claim 1, wherein the actuating member further includes a limiting member so that the elastic member aligned with the adjusting window can be positioned between the limiting member and the second upright flange of the actuating member.

3. The door lock mechanism as defined in claim 1, wherein a length of the second hook member of the actuating plate is greater than that of the second end of the elastic member, and thus the second end of the elastic member cannot release from the second hook member of the actuating plate when the first end of the elastic member disconnects from the hook member of the mounting plate.

4. The door lock mechanism as defined in claim 1, further comprising an inside doorknob and a spindle rotatably connected to the mounting plate, and the spindle employs at least one screw member to connect to the inside doorknob.

5. The door lock mechanism as defined in claim 4, wherein the spindle further includes a positioning rib, and an axle hole of the inside doorknob correspondingly includes a positioning groove to engage with the positioning rib of the spindle.

6. The door lock mechanism as defined in claim 4, wherein the spindle further combines with an actuating rod which is formed a non-circular rod, a connection rod and a non-circular head.

7. The door lock mechanism as defined in claim 6, wherein the non-circular rod, the connection rod and the non-circular head are integrally formed in a casting or milling manner.
